(19) United States
(12) Patent Application Publication
(10) Pub. No.: US 2014/0104785 A1
(43) Pub. Date: Apr. 17, 2014

(54) COOLING SYSTEM FOR SERVER SYSTEM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/049,279

(22) Filed: Oct. 9, 2013

(30) Foreign Application Priority Data
Oct. 11, 2012 (CN) 2012103829084

(51) Int. Cl. G06F 1/20

(52) U.S. Cl. CPC G06F 1/20
USPC 361/679.48

(57) ABSTRACT

A server system that includes a rack defining a number of spaces arranged in different levels of the rack includes a number of servers received in the spaces. A cooling system includes a number of fans arranged on an outer back of the number of servers. Two of the servers arranged on two different levels of the rack share at least two fans. The two servers supply power to the fans through different fan backplanes to form corresponding inlet and outlet channels for cooling the servers.

### BACKGROUND

1. Technical Field

The present disclosure relates to a cooling system for a server system.

2. Description of Related Art

A server system includes a number of servers. Each server includes a number of fans for cooling the server. When the number of servers increases, the number of fans must increase to effectively cool the servers. However, arrangement of the fans is complex, thereby increasing costs.

Therefore, what is needed is a means to overcome the above described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a front view of an exemplary embodiment of a server system.

FIG. 2 is a back view of the server system of FIG. 1.

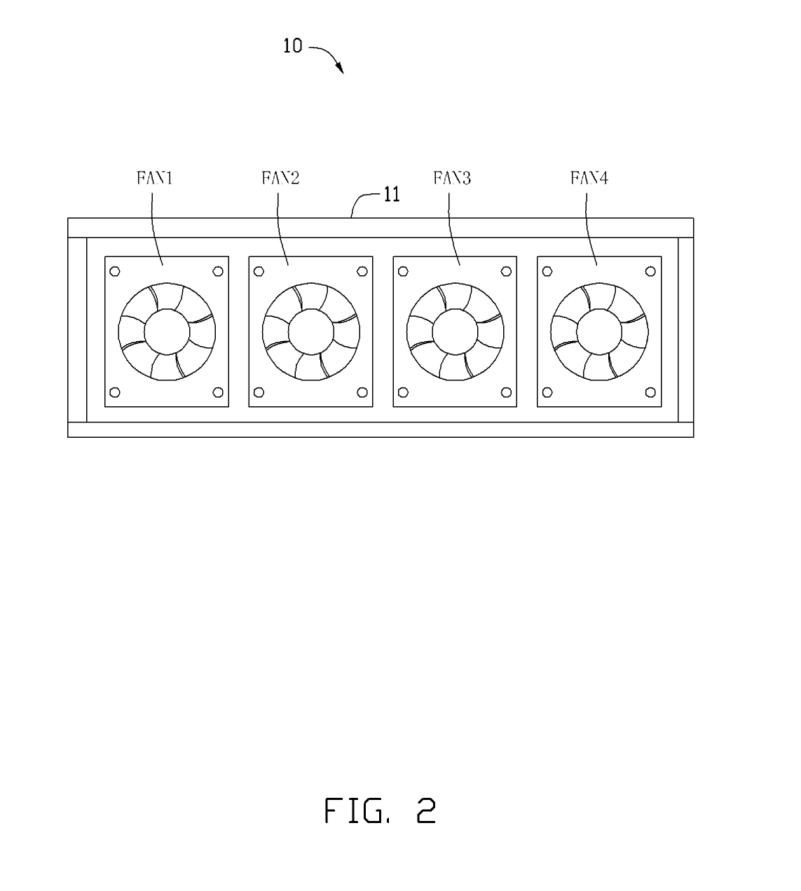

FIG. 3 is a schematic block diagram of the server system of FIG. 1.

### DETAILED DESCRIPTION

Reference will be made to the drawings to describe various embodiments.

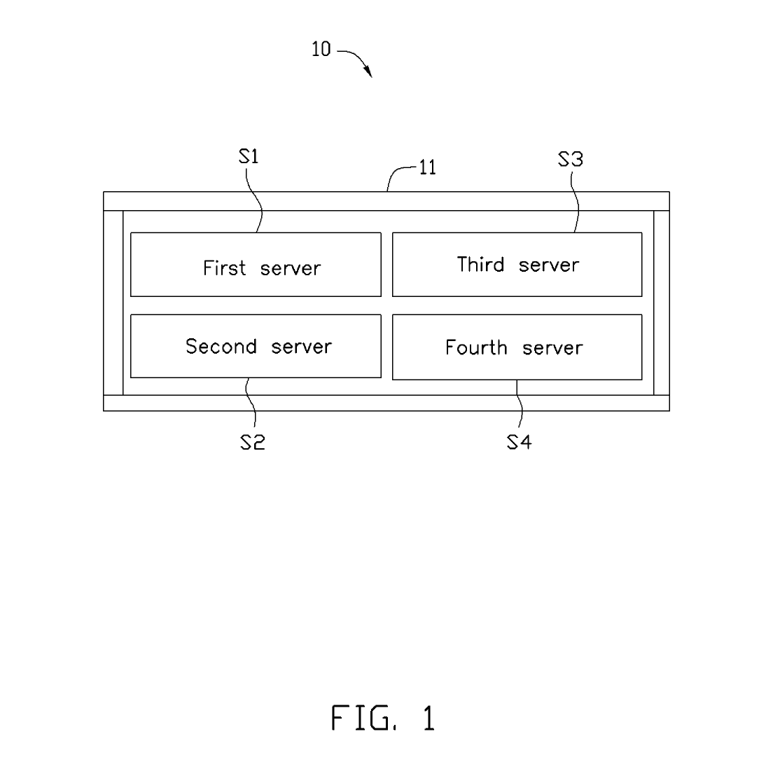

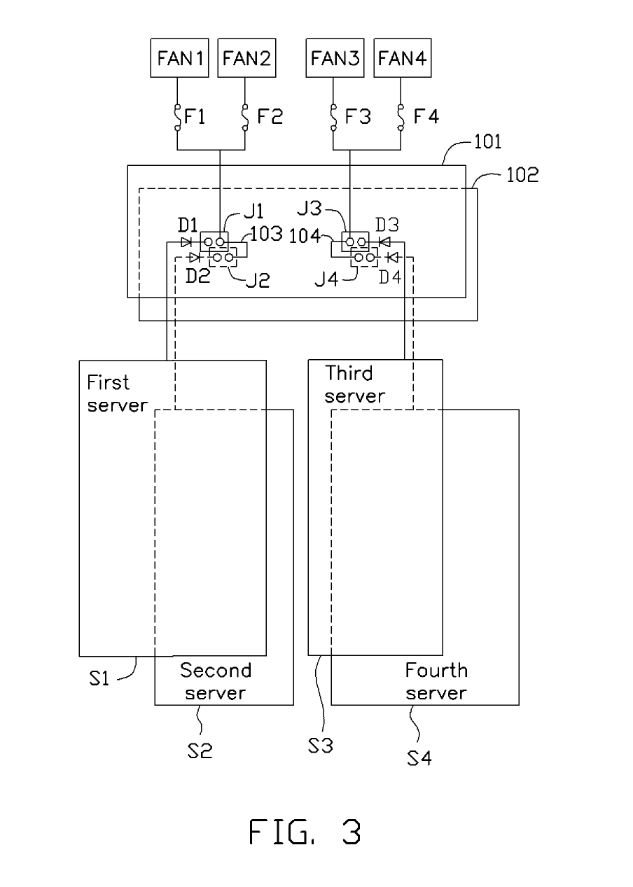

FIG. 1 shows a server system 10 that includes a rack 11 and a plurality of servers S1-S4 arranged on different levels of the rack 11. A plurality of fans FAN1-FAN4 is arranged on an outer back of the servers S1-S4, respectively. A number of the fans is equal to a number of the servers. The servers supply power to the fans via corresponding fan backplanes (see FIG. 3).

In the embodiment, a height of the rack 11 is 2 U (U is a size of measure that describes the height of the rack, where 1 U=1.75 inches). The rack 11 is divided into two levels. The first server S1 and the third server S3 are arranged on the upper level, and the second server S2 and the fourth server S4 are arranged on the lower level. The first, second, third, and fourth fans FAN1-FAN4 cooperatively form a fan wall for cooling the servers S1-S4.

FIG. 3 is a schematic block diagram of the server system 10. The first and the second servers S1 and S2 are both electrically connected to the first and second fans FAN1, FAN2 through a first fan backplane 101 and a second fan backplane 102. The third and fourth servers S3 and S4 are both electrically connected to the third and fourth fans FAN3, FAN4 through the first fan backplane 101 and the second fan backplane 102. The first fan backplane 101 is arranged on the same level as the first and third servers S1, S3. The second fan backplane 102 is arranged on the same level as the second and fourth servers S2, S4.

A first diode D1, a third diode D3, a first connector J1, and a third connector J3 are arranged on the first fan backplane 101. A second diode D2, a fourth diode D4, a second connector J2, and a fourth connector J4 are arranged on the second fan backplane 102.

An anode of the first diode D1 is electrically connected to the first server S1. A cathode of the first diode D1 is electrically connected to the first fan FAN1 via the first connector J1 and a first fuse F1, and is further electrically connected to the second fan FAN2 via the first connector J1 and a second fuse F2. An anode of the third diode D3 is electrically connected to the third server S3. A cathode of the third diode D3 is electrically connected to the third fan FAN3 via the third connector J3 and a third fuse F3, and is further electrically connected to the fourth fan FAN4 via the third connector J3 and a fourth fuse F4. In the embodiment, the anode of the first diode D1 is electrically connected to a power source (not shown) of the first server S1, and the anode of the third diode D3 is electrically connected to a power source (not shown) of the third server S3.

The second connector J2 is electrically connected to the first connector J1 through a first cable 103. The fourth connector J4 is electrically connected to the third connector J3 via a second cable 104. The anode of the second diode D2 is electrically connected to the second server S2, and the cathode of the second diode D2 is electrically connected to the second connector J2. The anode of the fourth diode D4 is electrically connected to the fourth server S4, and the cathode of the fourth diode D4 is electrically connected to the fourth connector J4. In the embodiment, the anode of the second diode D2 is electrically connected to a power source (not shown) of the second server S2, and the anode of the fourth diode D4 is electrically connected to a power source (not shown) of the fourth server S4.

In operation, when the first server S1 works normally, the first server S1 supplies power to the first fan FAN1 and the second fan FAN2 via the first diode D1 and the first connector J1. When the second server S2 works normally, the second server S2 supplies power to the first fan FAN1 and the second fan FAN2. When the first and second server S1, S2 both work normally, the first and second server S1, S2 supply power to the first and second fan FAN1, FAN2 simultaneously. The first fan FAN1 and the second fan FAN2 form an inlet and outlet channel to cool the server S1.

When the second server S3 works normally, the second server S3 supplies power to the third fan FAN3 and the fourth fan FAN4 via the third diode D3 and the third connector J3. When the fourth server S4 works normally, the fourth server S4 supplies power to the third fan FAN3 and the fourth fan FAN4. When the third and fourth server S3, S4 both work normally, the third and fourth server S3, S4 supply power to the third and fourth fan FAN3 and FAN4 simultaneously. The third fan FAN3 and the fourth fan FAN4 form an inlet and outlet channel.

In summary when two servers arranged on two levels of the rack share at least two fans, the two servers supply power to the at least two fans through a fan backplane to form an inlet and outlet channel for cooling the two servers, thus reducing the number of fans required to effectively cool the server system.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A sever system, comprising:
a rack;
a plurality of servers arranged on different levels of the rack; and
a plurality of fans arranged on an outer back of the servers;
wherein two of the servers arranged on two different levels of the rack share at least two fans such that the two servers supply power for the at least two fans via different fan backplanes, wherein the different fan backplanes form corresponding inlet and outlet channels for cooling the two servers.

2. The server system of claim 1, wherein a height of the rack is 2 U.

3. The server system of claim 2, wherein the servers comprise a first server, a second server, a third server, and a fourth server, and the rack is divided into an upper level and a lower level, the first and third server are arranged on the upper level, and the second and fourth server are arranged on the lower level.

4. The server system of claim 3, wherein the fans comprise a first fan, a second fan, a third fan and a fourth fan, the first fan and the third fan are shared by the first server and the third server, and the second fan and the fourth fan are shared by the second server and the fourth server.

5. The server system of claim 4, wherein the first server and the third server provide power via a first fan backplane arranged on the upper level, and the second server and the fourth server provide power via a second fan backplane arranged on the lower level.

6. The server system of claim 5, wherein a first diode, a second diode, a first connector, and a second connector are arranged on the first fan backplane, an anode of the first diode is electrically connected to the first server, a cathode of the first diode is electrically connected to the first and second fan via the first connector; an anode of the second diode is electrically connected to the third server, and a cathode of the second diode is electrically connected to the third and fourth fan via the second connector.

7. The server system of claim 6, wherein a first fuse is electrically connected between the cathode of the first diode and the first fan, a second fuse is electrically connected between the cathode of the first diode and the second fan, a third fuse is electrically connected between the cathode of the second diode and the third fan; and a fourth fuse is electrically connected between the cathode of the second diode and the fourth fan.

8. The server system of claim 6, wherein a third diode, a fourth diode, a third connector, and a fourth connector are arranged on the second fan backplane, the third connector is electrically connected to the first connector via a first cable, and the fourth connector is electrically connected to the second connector via a second cable.

9. The server system of claim 8, wherein an anode of the third diode is electrically connected to the second server, a cathode of the third diode is electrically connected to the third connector; an anode of the fourth diode is electrically connected to the fourth server, and a cathode of the fourth diode is electrically connected to the fourth connector.

10. A cooling system in a server system including a rack, a plurality of servers arranged on different levels of the rack, comprising:
a plurality of fans arranged on an outer back of the server;
wherein two of the servers arranged on the two different levels of the rack share at least two fans, the two servers supply power for the at least two fans via different fan backplanes, wherein the different fan backplanes form corresponding inlet and outlet channels for cooling the two servers.

11. The cooling system of claim 10, wherein a height of the rack is 2 U.

12. The cooling system of claim 11, wherein servers comprise a first server, a second server, a third server, and a fourth server, and the rack is divided into an upper level and a lower level, the first and third server are arranged on the upper level, and the second and fourth server are arranged on the lower level.

13. The cooling system of claim 12, wherein the fans comprise a first fan, a second fan, a third fan and a fourth fan, the first fan and the third fan are shared by the first server and the third server, and the second fan and the fourth fan are shared by the second server and the fourth server.

14. The cooling system of claim 13, wherein the first server and the third server provide power via a first fan backplane arranged on the upper level, and the second server and the fourth server provide power via a second fan backplane arranged on the lower level.

15. The cooling system of claim 14, wherein a first diode, a second diode, a first connector, and a second connector are arranged on the first fan backplane, an anode of the first diode is electrically connected to the first server, a cathode of the first diode is electrically connected to the first and second fan via the first connector; an anode of the second diode is electrically connected to the third server, and a cathode of the second diode is electrically connected to the third and fourth fan via the second connector.

16. The cooling system of claim 15, wherein a first fuse is electrically connected between the cathode of the first diode and the first fan, a second fuse is electrically connected between the cathode of the first diode and the second fan, a third fuse is electrically connected between the cathode of the second diode and the third fan; and a fourth fuse is electrically connected between the cathode of the second diode and the fourth fan.

17. The cooling system of claim 15, wherein a third diode, a fourth diode, a third connector, and a fourth connector are arranged on the second fan backplane, the third connector is electrically connected to the first connector via a first cable, and the fourth connector is electrically connected to the second connector via a second cable.

18. The cooling system of claim 17, wherein an anode of the third diode is electrically connected to the second server, a cathode of the third diode is electrically connected to the third connector; an anode of the fourth diode is electrically connected to the fourth server, and a cathode of the fourth diode is electrically connected to the fourth connector.

19. A sever system, comprising:
a rack;
a plurality of fans arranged in the back of the plurality of servers; and
a plurality of servers arranged in an m X n matrix in the rack, wherein at least two fans commonly employed by two of the servers arranged at the different rows and a same column for cooling the two servers, and the two servers supply power for the at least two fans via different fan backplanes to form corresponding inlet and outlet channels for cooling the two servers, and wherein m=2, 3, 4 . . . ; n=1, 2, 3, . . .
